(19) United States
(12) Patent Application Publication
(10) Pub. No.: US 2004/0264523 A1
(43) Pub. Date: Dec. 30, 2004

(54) Temperature compensation circuit to maintain ratio of monitor photodiode current to fiber coupled light in a laser

(76) Inventor: Joshua D. Posamentier, Oakland, CA (US)

Correspondence Address: Jan Carol Little, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/643,653

(22) Filed: Aug. 19, 2003

Related U.S. Application Data
(63) Continuation-in-part of application No. 10/611,257, filed on Jun. 30, 2003, now abandoned.

(51) Int. Cl. H01S 3/00; H01S 3/13

(52) U.S. Cl. 372/38.01; 372/38.02; 372/38.07; 372/29.011; 372/29.015

(57) ABSTRACT

Embodiments of the present invention include a thermistor and resistor network coupled to change the effective responsivity of a monitor photodiode positioned to monitor laser power output to compensate for changes in optical fiber tracking caused by changes in temperature and maintain constant or proportional the ratio of light coupled into the optical fiber to the light coupled to the monitor photodiode.

### RELATED APPLICATION

This application is a continuation-in-part of Ser. No. 10/611,257, filed Jun. 30, 2002.

### BACKGROUND

1. Field

Embodiments of the present invention relate to laser systems and, in particular, to temperature compensation in lasers systems.

2. Discussion of Related Art

An optical telecommunication system transmits information from one place to another by way of an optical carrier whose frequency typically is in the visible or near-infrared region of the electromagnetic spectrum. A carrier with such a high frequency is sometimes referred to as an optical signal, an optical carrier, optical beam, or a lightwave signal.

A typical optical telecommunication system includes several optical fibers and each optical fiber includes multiple channels. A channel is a

A typical optical telecommunication system includes several optical fibers and each optical fiber includes multiple channels. A channel is a specified frequency band of an electromagnetic signal, and is sometimes referred to as a wavelength. The purpose for using multiple channels in the same optical fiber (called dense wavelength division multiplexing (DWDM)) is to take advantage of the unprecedented capacity (i.e., bandwidth) offered by optical fibers. Essentially, each channel has its own wavelength, and all wavelengths are separated enough to prevent overlap. The International Telecommunications Union (ITU) currently determines the channel separations.

One link of an optical telecommunication system typically has a transmitter, the optical fiber, and a receiver. The transmitter has a light source, which converts an electrical signal into the optical signal and launches it into the optical fiber. There is information on a data stream in the electrical signal that is also present in the optical signal. The optical fiber transports the optical signal to the receiver. The receiver converts the optical signal back into an electrical signal and recovers the information from the data stream. Laser systems, such as those that use distributed feedback (DFB) lasers, external cavity lasers (ECL), and vertical cavity surface emitting lasers (VCSELs), are common light sources.

To ensure proper operation of any laser system, many of the parameters (e.g., power, channel, temperature) are controlled and monitored by control loops. One such control loop is an automatic power control loop, which is designed to maintain constant the light out of the laser, typically because as lasers age the light output at a given current decreases.

In an automatic power control loop, a monitor photodiode may be positioned to monitor light out of the laser. In a DFB laser, light from the front facet of the laser is coupled into the optical fiber and light from the back facet of the laser is coupled into the monitor photodiode. In a VCSEL, light from the top of the laser is coupled into the optical fiber through a lens. Light backscattered off the lens is coupled into the monitor photodiode. As a function of temperature or age, the monitor photodiode senses the decrease in the light due to temperature and/or age from the laser and increases the bias current to the laser accordingly.

One limitation of this setup is that because of its position the monitor photodiode cannot determine how much light is being coupled into the fiber, only what is being output by the laser illuminating the monitor photodiode where it is positioned (i.e., the back facet, the bottom of the laser). Thus, if the amount of light coupled into the optical fiber decreases, due to temperature changes experienced by the optical fiber, mechanical flexures, or aging of laser face coatings, for example, the monitor photodiode does not increase the laser bias current to maintain a constant amount of light being coupled into the optical fiber. As a result, as the temperature increases, the amount of light coupled into the optical fiber decreases. This can mean that received light levels are so low that individual bits in the data stream in the optical signal become indistinguishable.

### BRIEF DESCRIPTION OF THE DRAWINGS

In the drawings, like reference numbers generally indicate identical, functionally similar, and/or structurally equivalent elements. The drawing in which an element first appears is indicated by the leftmost digit(s) in the reference number, in which:

FIG. 1 illustrates a high-level block diagram of a laser system according to an embodiment of the present invention;

FIG. 2 is a flowchart showing an approach to operating the laser system in FIG. 1 according to an embodiment of the present invention;

FIG. 3 is a schematic diagram of the laser system illustrated in FIG. 1 according to an embodiment of the present invention;

FIG. 4 is a high-level block diagram of a communication system 400 according to an embodiment of the present invention; and

FIG. 5 is a high-level block diagram of a laser system according to an alternative embodiment of the present invention.

### DETAILED DESCRIPTION OF THE ILLUSTRATED EMBODIMENTS

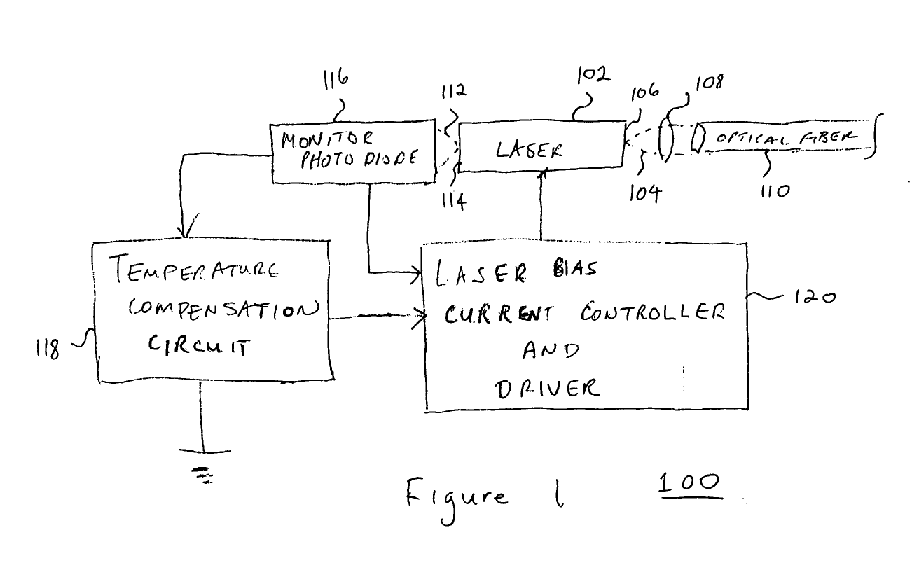

FIG. 1 illustrates a high-level block diagram of a laser system 100 according to an embodiment of the present invention. In one embodiment, the example laser system 100 is an un-cooled laser system that includes circuitry to compensate for the case where the ratio of light coupled into an optical fiber to the light coupled to a monitor photodiode changes as a function of temperature. As a result, the example laser system 100 ensures that the ratio of light coupled into the optical fiber to the light coupled to the monitor photodiode remains constant or proportional when temperature changes affect optical fiber tracking.

The example laser system 100 includes a distributed feedback (DFB) laser 102 that emits an optical beam 104 from a front facet 106. A lens 108 focuses the optical beam 104 onto an optical fiber 110. There may be an optical isolator (not shown) positioned between the lens 108 and the optical fiber 110. The laser 102 also emits an optical beam 112 from a back facet 114. The optical beam 112 is incident on a monitor photodiode 116 whose output is coupled to a temperature compensation circuit 118. The output of the temperature compensation circuit 118 is coupled to a laser bias current controller and driver circuit 120. The output of the laser bias current controller and driver circuit 120 is coupled to the laser 102.

Although embodiments of the present invention are described with respect to a distributed feedback (DFB) laser, it is to be understood that various embodiments may be implemented using vertical cavity surface emitting lasers (VCSEL) or other suitable lasers.

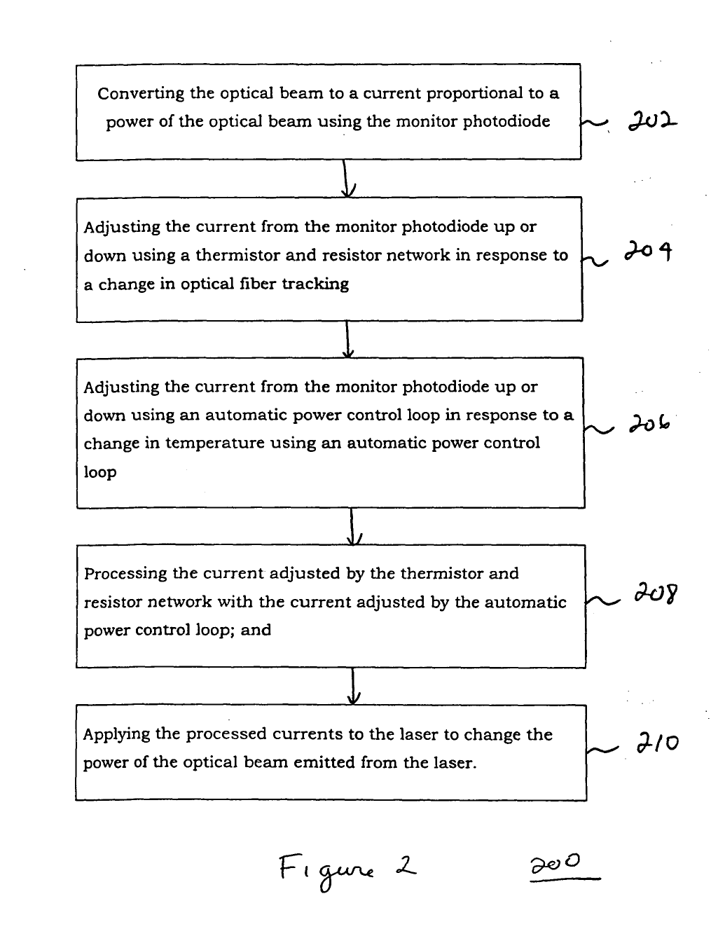

It is difficult for the optical fiber 110 to track the optical beam 104 as temperature increases. The monitor photodiode 116 substantially tracks the optical beam 112 as temperature increases. FIG. 2 is a flowchart showing a method 200 for operating the laser system 100 according to an embodiment of the present invention so that the ratio of light coupled into the optical fiber 110 to light coupled to the monitor photodiode 116 remains constant or proportional as temperature changes affect optical fiber 110 tracking of the optical beam 104. Of course, the method 200 is only an example process and other processes may be used. The order in which they are described should not be construed to imply that these operations are necessarily order-dependent or that the operations be performed in the order in which the operations are presented.

In a block 202, the example monitor photodiode 116 converts light from the optical beam 112 to a current proportional to the light from the optical beam 112. The current is then coupled to the temperature compensation circuit 118. For example, the laser 102 turns on and emits the optical beam 104 from the front facet 106 and the optical beam 112 from the back facet 114, in response to a value set by the laser bias current controller and driver circuit 120, for example. The optical beam 104 is coupled into the optical fiber 110 and the optical beam 112 is coupled into the monitor photodiode 116. In one embodiment of the present invention, the optical beam 104 is substantially the same as the optical beam 112. In an alternative embodiment, the optical beam 104 has a known proportionality to the optical beam 112.

In a block 204, the example temperature compensation circuit 118 receives the current from the monitor photodiode 116 and adjusts the current up or down in response to a change in optical fiber 110 tracking due to temperature effects. The temperature experienced by the temperature compensation circuit 118 is substantially the same as the temperature experienced by the optical fiber 110. The current output from the temperature compensation circuit 118 is applied to the laser bias current controller and driver circuit 120.

In a block 206, the automatic power control loop adjusts the current from the monitor photodiode 116 in response to laser temperature and/or aging. The automatic power control loop includes the monitor photodiode 116, portions of the laser bias current controller and driver circuit 120, and the laser 102 without the temperature compensation circuit 118.

In a block 208, the example laser bias current controller and driver circuit 120 processes (e.g., adds, subtracts, mixes, etc.) the current adjusted by the temperature compensation circuit 118 and current adjustments called for by the automatic power control loop.

In block 210, the laser bias current controller and driver circuit 120 applies the processed currents to the laser 102 accordingly to change the light level of the optical beams 104 and 112 (i.e., the optical power). Thus, as the optical fiber 110 tracking changes due to temperature, the light coupled into the optical fiber 110 changes accordingly so that the ratio of light coupled into the optical fiber 110 is directly proportional to the monitor photodiode 116 current across temperature.

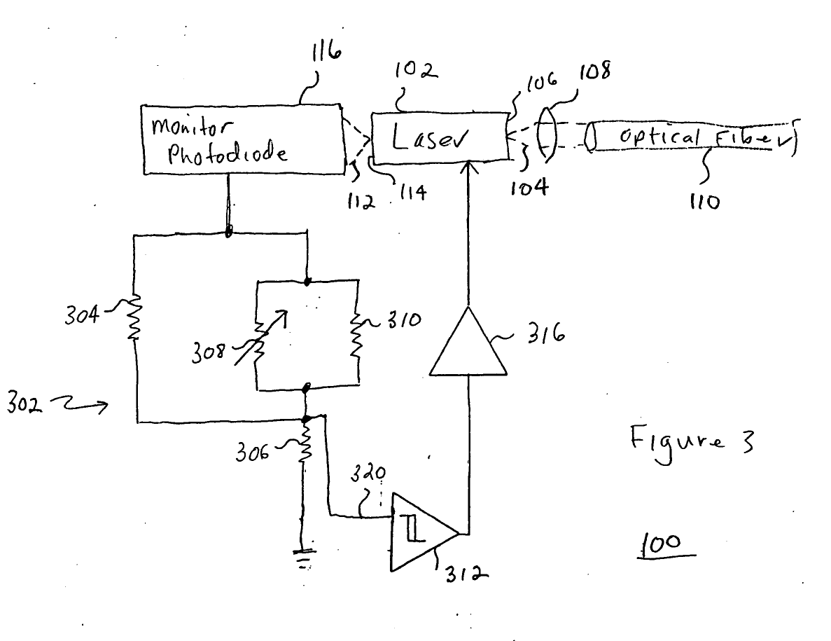

FIG. 3 is a schematic diagram of the laser system 100 according to an alternative embodiment of the present invention. FIG. 3 shows the laser 102 emitting the optical beam 104 from the front facet 106, the lens 108 focusing the optical beam 104 onto the optical fiber 110, the laser 102 emitting the optical beam 112 from the back facet 114, and the optical beam 112 incident on the monitor photodiode 116. FIG. 3 also shows the output of the monitor photodiode 116 coupled to a resistance network 302. The resistance network 302 adjusts the current from the monitor photodiode 116 as temperature changes to change the effective responsivity (with units of Amps per Watt) of the monitor photodiode 116 so that the optical fiber 110 can track the optical beam 104 as a function of temperature.

The example resistance network 302 includes a resistor 304, a resistor 306, a thermistor 308, and an optional resistor 310. The resistance network 302 is coupled to one input of an integrator 312. The output of the integrator 312 is coupled to a current gain device 316. The output of the current gain device 316 is coupled to the laser 102.

The example resistor 304 senses the current output from the monitor photodiode 116 and converts the current to a voltage proportional to the current. In one embodiment, the resistor 304 may be approximately one hundred ohms.

In one embodiment of the present invention, the resistor 306 may be approximately 560 k ohms.

The example thermistor 308 has a negative temperature coefficient and its resistance may change exponentially with temperature with the degree of change and its slope to be partially determined by the device specific β value. For example, as temperature increases, the resistance of the thermistor 308 may decrease. Conversely, at lower temperatures, the thermistor 308 has a high resistance. As the resistance of the thermistor 308 decreases, the proportional current to the laser 102 increases. As current to the laser 102 increases, the light in the optical beams 104 and 112 increases. In one embodiment of the present invention, the thermistor 308 may be approximately 10 k ohms at twenty-five decrees Centigrade (C) with a beta (β) approximately equal to 4,225K. The temperature rating defines a set point for the thermistor 308. The beta (β) defines the curvature of the resistance slope for the thermistor 308.

The example resistor 310 may be used to change the exponential temperature slope of the thermistor 308.

The example thermistor 308 in parallel with the example resistor 310 together as one effective resistor act as the topside of a voltage divider. Because the thermistor 308 has a negative temperature coefficient, its exponential resistance range requires a large bottom part of the divider. The values must conform to the equation:

R 306+(thermistor 308+R 310)>>R 304 Equation (1)

so that the sense voltage (voltage only, no current) does not affect the voltage drop across the resistor 304.

The output of the resistor network 302 is felt at a point 320 and is adjusted for temperature. The voltage felt at the point 320 is applied to one input of the integrator 312.

The example integrator 312 provides an output voltage that is proportional to the integral of the input voltage. Integrator operation is known and the integrator 312 may be an off-the shelf integrator.

The example current gain device 316 converts the voltage input from the integrator 312 to a current and drives the laser 102 with the current (i.e., laser bias current). The current gain device may be a field effect transistor, a bipolar junction transistor, or suitable current gain device. The integrator 312, the DAC 314, and the current gain device 316 may be on the same chip.

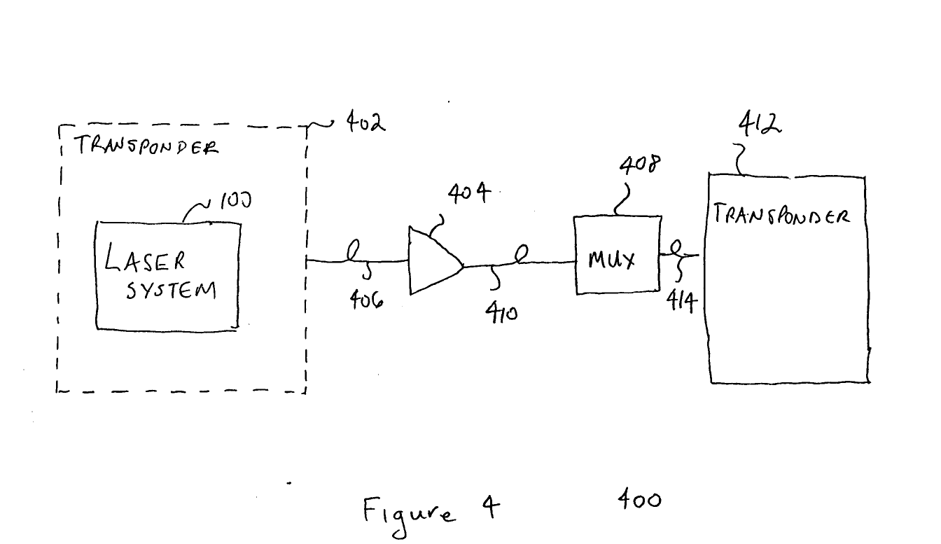

FIG. 4 is a high-level block diagram of a communication system 400 according to an embodiment of the present invention. The system 400 includes a transponder 402 coupled to an optical amplifier 404 via an optical fiber 406. The optical amplifier 404 is coupled to a multiplexer 408 via an optical fiber 410. The multiplexer 408 is coupled to a transponder 412 via an optical fiber 414. The transponder 402 includes the laser system 100. Although only one transponder 402, optical amplifier 404, optical fibers 406, 410, and 414, multiplexer 408, and transponder 412 are shown, it is common to have numerous transponders, optical amplifiers, optical fibers, and multiplexers in optical communication systems. Single units are shown for simplicity.

The transponder 402 may transmit optical beams generated by the laser 100. Although not shown for purposes of simplicity, the transponder 402 also may receive optical beams from the transponder 410.

The optical amplifier 406 may be an erbium (Er) doped fiber amplifier (EDFA). Alternatively, the optical amplifier 406 may be an ytterbium (Yb) doped fiber amplifier, a praseodymium (Pr) doped fiber amplifier, a neodymium (Nd) doped fiber amplifier, or other suitable optical amplifier.

The multiplexer 408 may be a DWDM multiplexer. Alternatively, the multiplexer 408 may be an add-drop multiplexer.

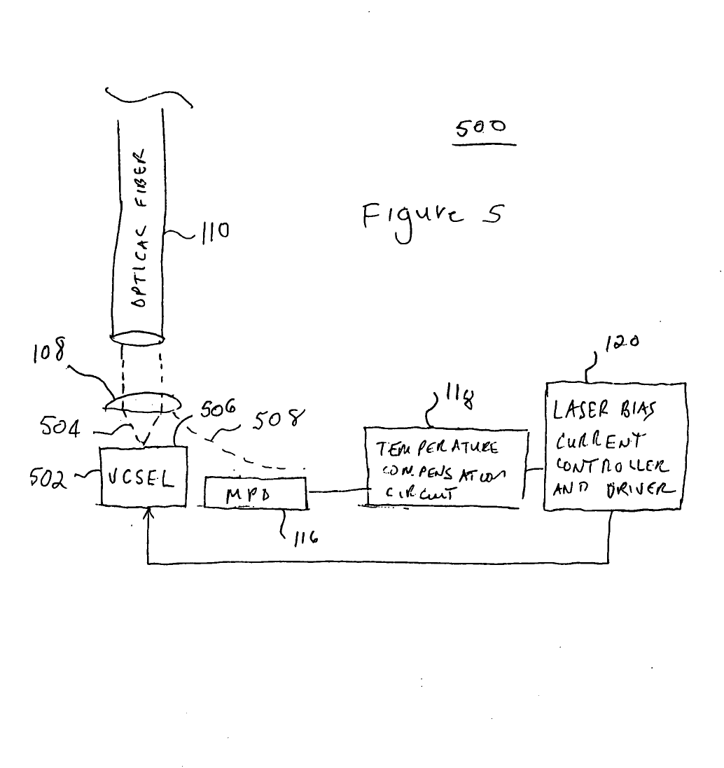

FIG. 5 illustrates a high-level block diagram of a laser system 500 according to an alternative embodiment of the present invention. The example laser system 500 includes a vertical cavity surface emitting laser (VCSEL)502 that emits an optical beam 504 from a top facet 506. The lens 108 focuses the optical beam 504 onto the optical fiber 110. Light 508 is backscattered from the lens 108 and is incident onto the monitor photodiode (MPD) 116 whose output is coupled to the temperature compensation circuit 118. The output of the temperature compensation circuit 118 is coupled to the laser bias current controller and driver circuit 120. The output of the laser bias current controller and driver circuit 120 is coupled to the VCSEL 502.

The example monitor photodiode 116 converts light from the backscattered light 508 to a current proportional to the light from the optical beam 504. The current is then coupled to the temperature compensation circuit 118. The example laser system 500 operation is then similar to the example laser system 100 operation.

Of course, embodiments of the present invention are not limited to communication systems. For example, embodiments of the present invention may be implemented in spectroscopy systems, metrology systems, sensing systems, research and development systems, and/or testing systems.

Embodiments of the invention can be implemented using hardware, software, firmware, or a combination of hardware and software. In implementations using software, the software may be stored on a computer program product (such as an optical disk, a magnetic disk, a floppy disk, etc.) or a program storage device (such as an optical disk drive, a magnetic disk drive, a floppy disk drive, etc.).

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description.

In the above description, numerous specific details, such as particular processes, materials, devices, and so forth, are presented to provide a thorough understanding of embodiments of the invention. One skilled in the relevant art will recognize, however, that the embodiments of the present invention can be practiced without one or more of the specific details, or with other methods, components, etc. In other instances, well-known structures or operations are not shown or described in detail to avoid obscuring the understanding of this description.

Various operations have been described as multiple discrete operations performed in turn in a manner that is most helpful in understanding embodiments of the invention. However, the order in which they are described should not be construed to imply that these operations are necessarily order dependent or that the operations be performed in the order in which the blocks are presented.

Reference throughout this specification to “one embodiment” or “an embodiment” means that a particular feature, structure, process, block, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method, comprising:
converting an optical beam emitted from a laser to a current proportional to a power of the optical beam using a monitor photodiode;
adjusting the current from the monitor photodiode up or down using a thermistor and resistor network to compensate for a change in optical fiber tracking;
adjusting the current from the monitor photodiode up or down using an automatic power control loop in response to a change in temperature using an automatic power control loop;
processing the current adjusted by the thermistor and resistor network with the current adjusted by the automatic power control loop; and
applying the processed currents to the laser to change the power of the optical beam emitted from the laser.

2. The method of claim 1, wherein the optical beam is emitted from a back facet of the laser.

3. The method of claim 2, wherein applying the processed currents to the laser to change the power of the optical beam emitted from the laser comprises applying the processed currents to the laser to adjust the power of the optical beam emitted from a front facet of the laser.

4. The method of claim 3, wherein applying the processed currents to the laser to adjust the power of the optical beam emitted from the front facet of the laser comprises maintaining constant a ratio of power of the optical beam emitted from the back facet of the laser to the power of the optical beam coupled into an optical fiber at the front facet of the laser.

5. The method of claim 1, further comprising coupling the optical beam to the monitor photodiode using lens backscatter.

6. The method of claim 5, wherein applying the processed currents to the laser to change the power of the optical beam emitted from the laser comprises applying the processed currents to the laser to adjust the power of the optical beam emitted from a top facet of the laser.

7. The method of claim 6, wherein applying the processed currents to the laser to adjust the power of the optical beam emitted from the top facet of the laser comprises maintaining constant a ratio of power of the optical beam emitted from the top facet and backscattered from a lens or other optical component into the monitor photodiode to the power of the optical beam coupled into an optical fiber at the top facet of the laser.

8. An apparatus, comprising:
a laser to emit an optical beam;
a photodiode coupled to receive the optical beam from the laser and to convert the optical beam to a current;
first circuitry coupled to receive the current and to adjust the current as temperature changes; and
second circuitry coupled to receive the adjusted current and to provide the adjusted current to the laser to adjust power in the optical beam emitted by the laser.

9. The apparatus of claim 8, wherein the first circuitry comprises a thermistor and resistor network coupled to receive the current from the photodiode.

10. The apparatus of claim 9, wherein the second circuitry comprises:
a current gain device having a first input and a second input; and
a digital-to-analog converter having an output coupled to the first input,
the thermistor network coupled to the second input.

11. The apparatus of claim 10, wherein the thermistor network has a negative temperature coefficient.

12. The apparatus of claim 10, wherein the laser is an un-cooled distributed feedback (DFB) laser.

13. The apparatus of claim 10, wherein the laser is an un-cooled vertical cavity surface emitting laser (VCSEL) laser.

14. A system, comprising:
a transponder having a laser to emit light, a photodiode coupled to receive light from the laser and to convert the light to a current, first circuitry coupled to receive the current and to adjust the current as temperature changes, and second circuitry coupled to receive the adjusted current and to provide the adjusted current to the laser to adjust light emitted by the laser; and
an erbium-doped fiber amplifier (EDFA) coupled to the transponder.

15. The system of claim 14, further comprising a multiplexer coupled to the EDFA.

16. The system of claim 15, further comprising an add-drop multiplexer coupled to the EDFA.
